(19) United States
(12) Patent Application Publication
(10) Pub. No.: US 2013/0125016 A1
(43) Pub. Date: May 16, 2013

(54) SYSTEM AND METHOD FOR TRANSFERRING CONTENT BETWEEN DEVICES

(71) Applicant: Barnesandnoble.com llc, New York, NY (US)

(72) Inventors: Matthew PALLAKOFF, Mountain View, CA (US); Luis Daniel MOSQUERA, Foster City, CA (US); Harold Edward COHN, Incline Village, NV (US)

(73) Assignee: Barnesandnoble.com llc, New York, NY (US)

(21) Appl. No.: 13/672,588

(22) Filed: Nov. 8, 2012

Related U.S. Application Data
(60) Provisional application No. 61/558,875, filed on Nov. 11, 2011.

(51) Int. Cl. G06F 3/0481

(52) U.S. Cl. CPC G06F 3/04817; H04L 67/06
USPC 715/748

(57) ABSTRACT

A system and a method for transferring content between devices are disclosed. In a preferred embodiment, users lay their electronic devices (such as content reading devices, mobile tablets or smart phones) side by side and use a touch screen to “slide” or “swipe” digital content (e.g., via finger swiping of a book cover) from one device to the other. The devices automatically pair with one another based on certain pairing criteria detected contemporaneously with slide or swipe of digital content. If the pairing criteria are satisfied, the digital content is transferred.

### FIELD OF THE INVENTION

The present invention generally relates to systems and methods for reading digital content, and more particularly to systems and methods for transferring digital content between devices.

### BACKGROUND OF THE INVENTION

Electronic devices that permit users to read various forms of electronic publications, such as eBooks, are known. These devices sometimes include a mechanism to permit one user to “lend” or “recommend” an electronic publication by transferring a copy of the publication, or a sample portion, from his/her device to the device of another person, such as a friend or relative. Such a transfer normally involves a series of click through menus and dialogs. This process, while not difficult, may be tedious and time consuming. A need is required for a system of transferring digital content between devices that is more fluid and fun.

### SUMMARY OF THE INVENTION

The present invention makes it possible for users to recommend and lend electronic publications from one electronic device to another when in proximity to one another. In accordance with one aspect of the present invention, users lay their devices (such as mobile tablets or smart phones) side by side and use a touch screen to “slide” or “swipe” digital content (e.g., via finger swiping of a book cover) from one device to the other. In the event that the digital content (e.g., an eBook) is not authorized for use on the other device, e.g., due to requirements of the content's publisher or because the content has already been lent, the receiving device receives only a sample portion of the book as a recommendation. If the content is authorized for use, the user of the receiving device is presented with various options, such as “Get Sample,” “Buy” and/or “Borrow,” or other options.

In accordance with one embodiment of the present invention, pairing of the devices is accomplished automatically without need for the users to perform any special pairing operation. The pairing of devices can be accomplished, for example, simply by virtue of the two devices being on the same Wi-Fi network or the same ad-hoc local area network established via Wi-Fi Direct or other means, with timing and, optionally, location, of the swipe being used to identify the sending and receiving devices. In one embodiment, the fingers slide onto the receiving device within about a second of leaving the sending device; and the swipe entrance location is directly across from the swipe exit location on opposite edges of the devices. This “location-of-the-swipe” constraint may be implemented, but is not essential to the invention, as the devices may be misaligned, or positioned head-to-side, or in some other physical configuration with respect to each other.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a sending and a receiving device placed in close physical proximity;

FIG. 2 illustrates dragging a recommended electronic publication from the sending to the receiving device;

FIG. 3 illustrates the recommended electronic publication being received on the receiving device;

FIG. 4 depicts the recommended electronic publication with a “Sample” banner on receiving device;

FIG. 5 illustrates dragging an electronic publication to lend from the sending to the receiving device;

FIG. 6 depicts the pop-up window displayed when receiving a loaned electronic publication on the receiving device;

FIG. 7 depicts the loaned electronic publication with a “Loaned” banner on the receiving device;

FIG. 8 illustrates an exemplary system according to the present invention; and

FIG. 9 illustrates the components of an exemplary device.

### DETAILED DESCRIPTION OF THE INVENTION

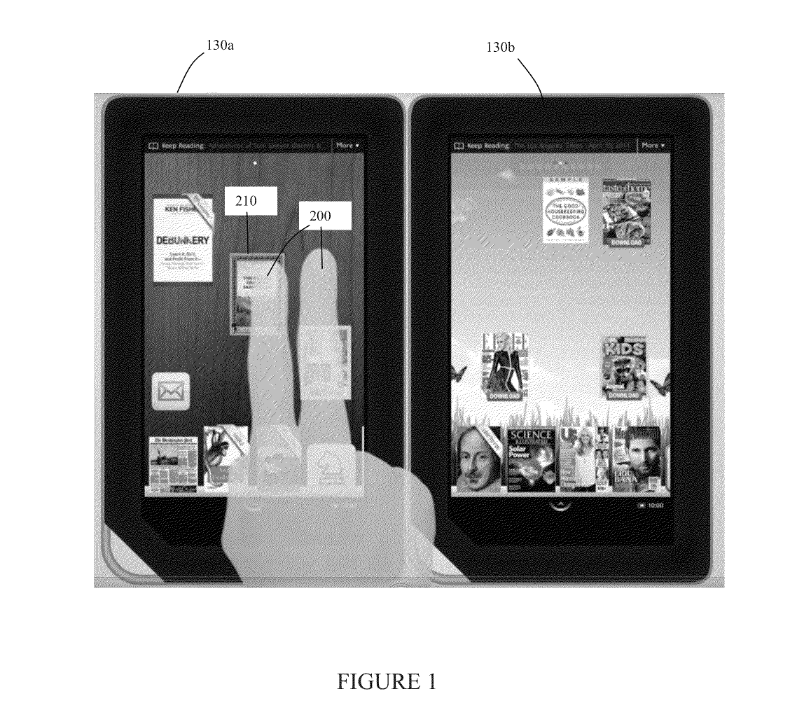

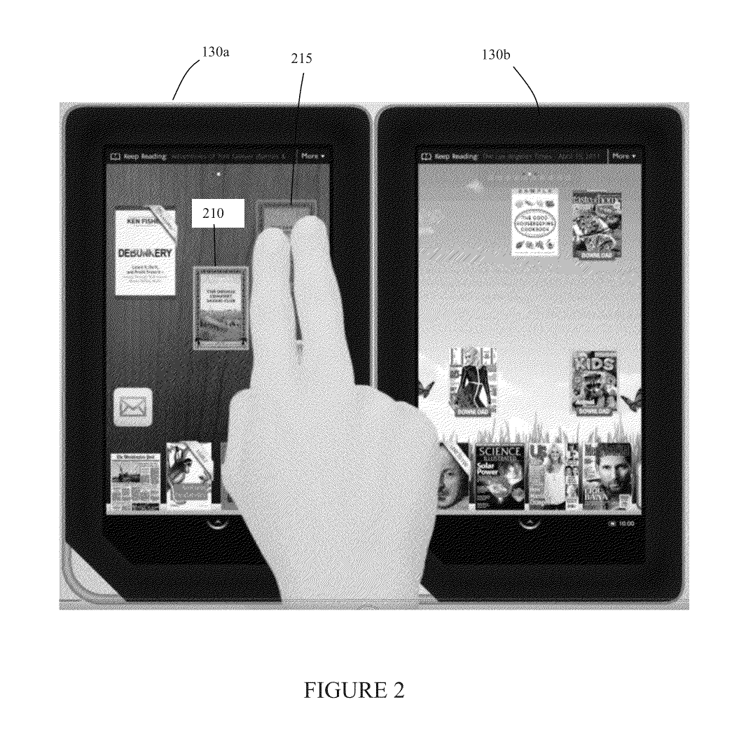

Referring now to FIGS. 1-4, there is seen a first embodiment of the present invention for transferring digital content from one electronic device to another. As shown in the Figures, devices 130a, 130b of a user and a friend are laid side-by-side on a table, with each device 130a, 130b displaying respective home screens. To transfer the digital content (e.g., item 210) from the user's device to the friend's device, the user performs a two-finger drag 200 (“2FD”) on the cover of item 210 and drags or “swipes” a semi-transparent copy 215 from the user's home screen, or other location, to the friend's home screen. Transferring semi-transparent copy 215, rather than item 210 itself, conveys the appearance that the user is not moving item 210, but rather just lending or recommending it. In another embodiment, a single-finger tap-and-drag (not shown) is used in place of the 2FD. In this embodiment, the user holds his/her finger still for at least a very brief moment, e.g., 1/10th second, before dragging. ND is preferable with respect to devices that use single-finger dragging for other functions.

In another embodiment, contact information is transferred and/or exchanged between devices 130a, 130b after the digital content is transferred. The user and/or friend may be asked whether he/she wishes to add the other to their address book or, alternatively, contact information may be automatically swapped if the user and/or friend change or set appropriate default settings on their respective devices 130a, 130b. If automatic swapping is enabled, it is preferable to display a toast or pop-up window requesting confirmation.

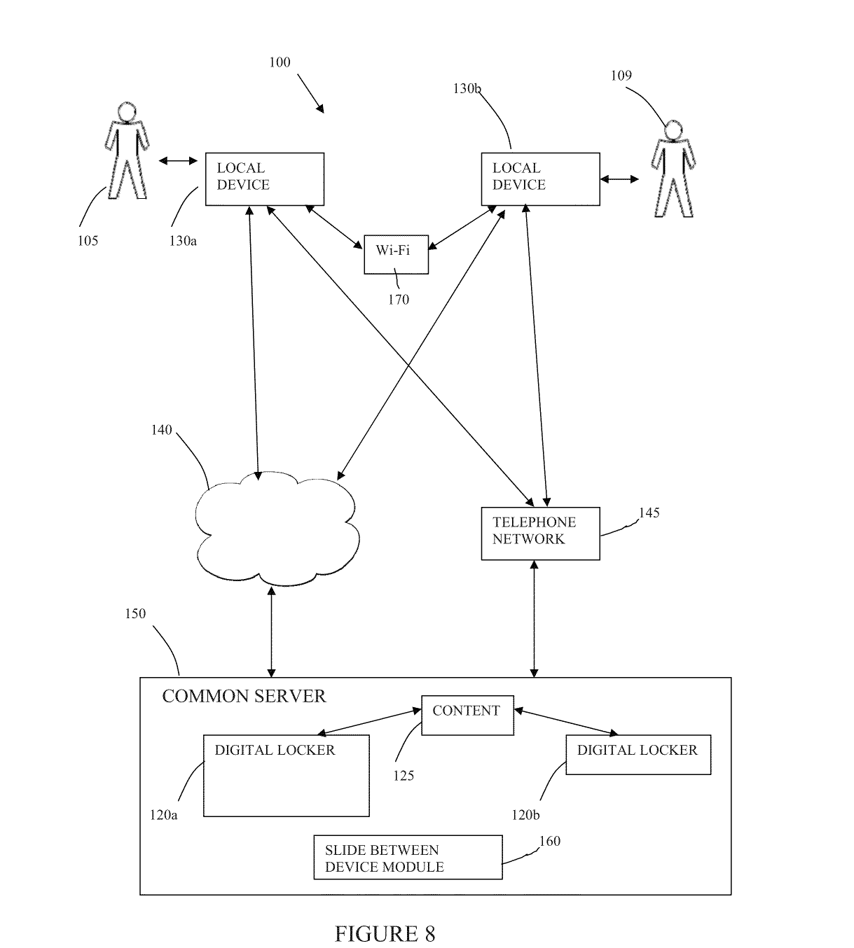

During the dragging operation, devices 130a, 130b communicate either directly (e.g., via Wi-Fi) or through network servers 150 (see FIG. 8) or the cloud. If the friend already owns a copy of the item 210, e.g., an application, a piece of content or eBook, a shortcut is added on the receiving device's home screen at the spot where the user completed the drag onto the device. Adding the shortcut in this manner is similar to the friend adding the shortcut to his/her home screen manually via an “Add to Home” command. The receiving device 130b may also display a toast or pop-up window to inform the user and friend of the completed action, such as a pop-up window stating “That item was already on this device. Here is a shortcut.”

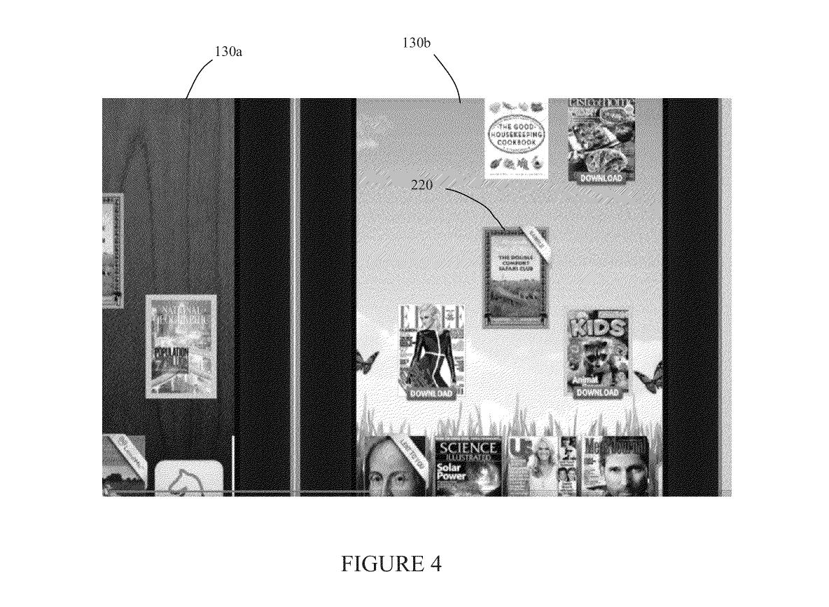

If item 210 is a non-purchased, manually loaded item (e.g., .pdf or Word™ file) a copy of item 210 is transferred to the receiving device 130b similarly to a traditional drag-and-drop copy between devices. If item 210, on the other hand, is a purchased item that can be recommended (i.e., it has associated sample content 220 that can otherwise be retrieved and downloaded by the friend's device) but not lent for any reason, the cover 220 of item 210 will be placed on the home screen of receiving device 130b, and the sample content associated with item 210 will automatically download to the device 130b in the same manner as if the friend chose to download the sample content manually, e.g., via “Get Sample” link from the item's detail page in a “Shop” application. In one embodiment, cover 220 of the sample content is marked with a label “SAMPLE,” as shown in FIG. 4.

It should be appreciated that certain types of items 210 may be prohibited from being transferred between devices. For example, in one embodiment, non-purchased, manually loaded items are prohibited from being transferred, although this is not particularly desirable.

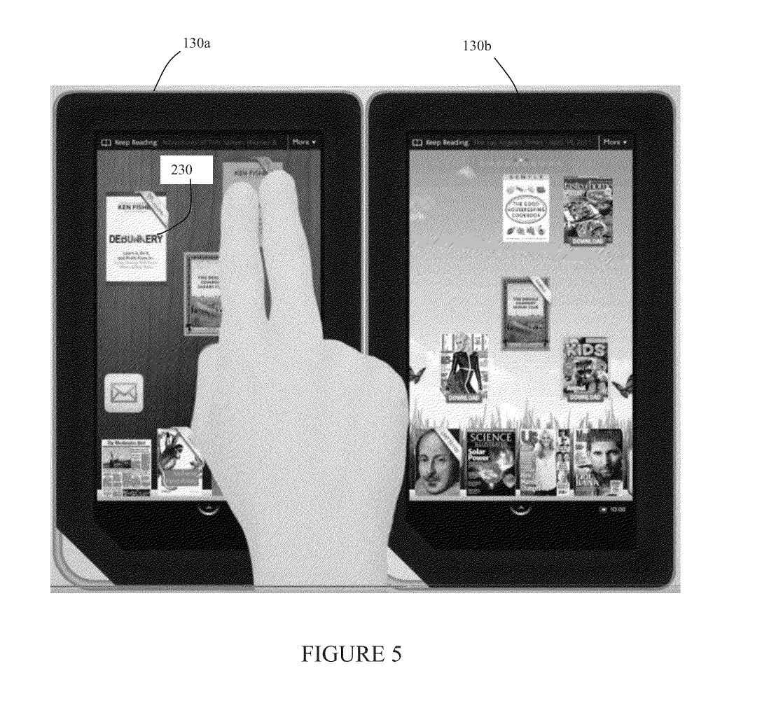

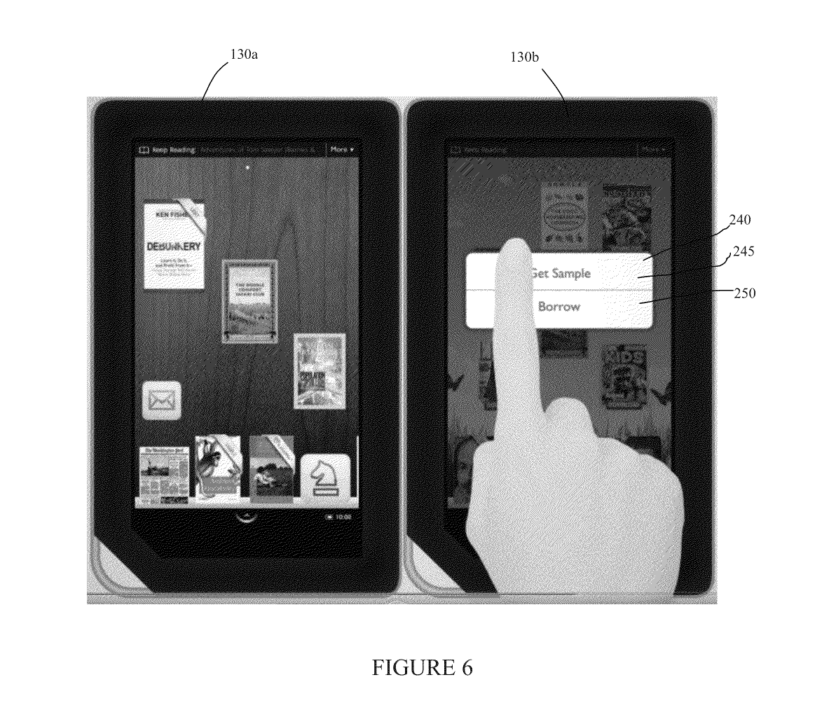

As illustrated in FIGS. 5-7, if an item 230 being dragged between devices 130a, 130b is digital content that can be loaned, i.e., a lendable item, item 230 does not immediately appear on the receiving device 130b. Rather, a context menu 240 is presented on the receiving device 130b with two choices (preferably just to the right of the final finger position to the extent there is room): “Borrow” 250 and “Get Sample” 245. In lieu of context menu 240, areas labeled “Recommend” and “Lend” may be displayed at the edge of user's device 130a, with the user dragging item 230 through one of the two areas to make a selection. Alternatively, “Borrow” 250 and “Get Sample” 245 options may be presented on the sending device 130a after the drag (or upon some gesture).

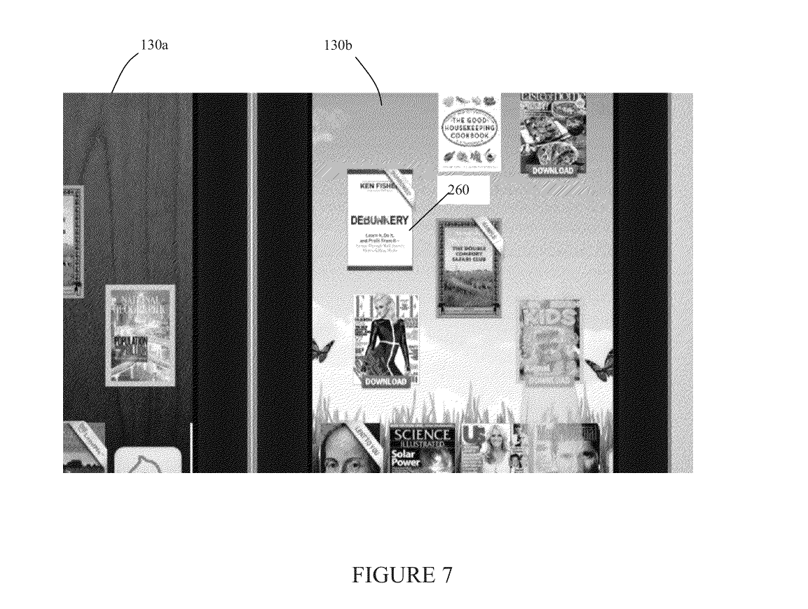

If the user or friend chooses “Borrow” 250, and item 230 is authorized for borrowing (e.g., via an external server in communication with the devices an icon 260 representing the item, e.g., the cover of an eBook, is placed on the home screen of receiving device 130b, for example, via an animation of icon 260 falling into place at the drop location. In one embodiment, icon 260 is marked with a label “BORROWED,” as shown in FIG. 7. Any requirement by device 130b for the friend to expressly “accept” the digital content may be omitted, as acceptance is implied (e.g., by virtue o the fact that devices 130a, 130b are positioned in close proximity to one another).

If the friend chooses “Get Sample” 245, and item 230 has associated sample content, an icon representing item 210, e.g., the cover of an eBook, is animated to appear to fall into place at the drop location. Similar to that described above, the cover of the sample content may be marked with a label “SAMPLE,” as shown in FIG. 4.

It should be appreciated that context menu 240 may display additional options, such as “Purchase,” “Share,” and/or “Add to Wishlist,” and so on. It should also be appreciated that default settings may obviate the need to display certain options or even context menu 240 altogether. For example, the friend may set his/her device 130b to always get sample content if available. In such a case, the above process can proceed automatically as if “Get Sample” 245 had been selected.

If item 230 can neither be lent nor provided as a sample, but can be purchased (e.g., via a “Shop” application), a detail page associated with item 230 is displayed in a “Shop” application, with the friend being given the option to purchase item 230 for download.

If none of the above apply to the item being dragged, or if it is determined that the desired transaction cannot be completed, a toast or pop-up window is displayed informing the user and friend that the drag and drop operating cannot be completed. Optionally and at approximately the same time as the toast or pop-up window is displayed, the cover outline of item 230 may be made to “poof” or disappear.

It may be the case that the default icon size of sending device 130a may be set larger or smaller than the default icon size of receiving device 130b. In such a case, item 230 is dragged to receiving device 130b using the icon size of sending device 130a and animated to the icon size of receiving device 130b after the user's fingers are lifted from receiving device 130b to complete the transfer. For example, if the default icon size of sending device 130a is larger than the default icon size of receiving device 130b, item 230 would remain large throughout the dragging process and shrink after the user's fingers are lifted from receiving device 130b.

Creating this extended “virtual space” between devices may have other uses besides transferring, lending and recommending files and items. For example, once a connection between devices 130a, 130b is established, the following actions may be enabled:
1. Dual-player gaming;
2. Application recommendations;
3. Share searches;
4. Share notes and highlights; and
5. Exchanging contact information (this might be automatically done the first time)

After establishing the connection with exchanged contact/device information, the sender could drag items to an action bubble instead of having to drag between devices 130a, 103b again. This would free users to move devices 130a, 103b anywhere and still share data as described above using the HD between two devices 130a, 103b.

When transferred from device 130a to device 130b, semi-transparent copy 215 appears to get dragged off the edge of device 130a, even though the user's fingers stop generating touch events as soon as they hit the frame of device 130a. To achieve this effect, the device continues moving the dragged copy 215 off the edge of device 130a after copy 215 hits the edge of device 130a and touch events cease, presuming that the user will continue to drag semi-transparent copy 215 to device 130b. If touch events cease while the user's fingers are not near a display edge, and no part of semi-transparent copy 215 is over the screen edge of device 130b, it is assumed that the user intended to cancel the transfer, with semi-transparent copy 215 disappearing thereafter (e.g., via fade, dissolve into dust, poof, etc.).

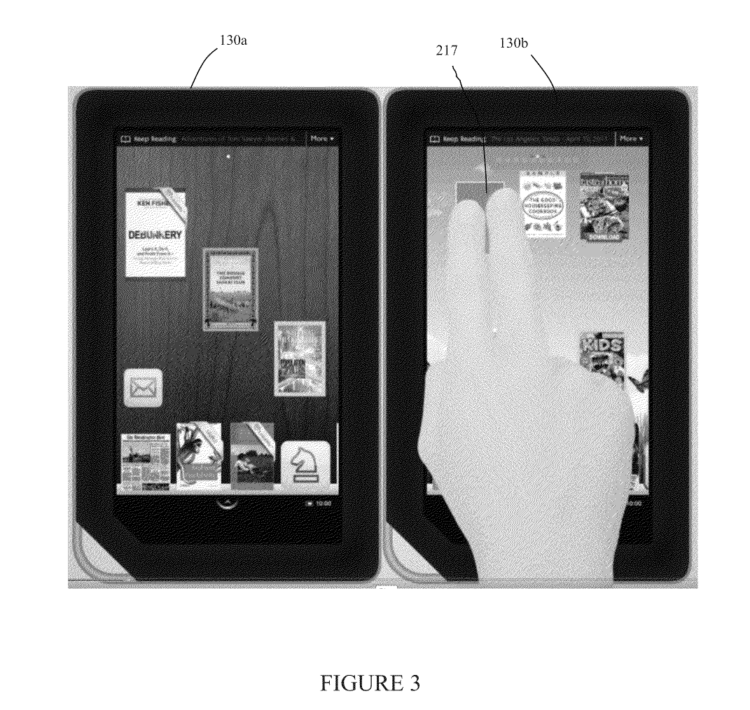

When the friend's device 103b senses a two finger drag onto its screen, i.e., a two finger drag whose first point of contact is within, say, ½ inch (90 px) of any edge and which is moving away from that edge toward the center, the friend's device 103b initially displays a simple rectangle 217 (see FIG. 3), suggestive of an unknown cover, until device 130a finishes transferring data representing the item's cover, at which point the rectangle will be replaced with an icon showing the cover. If the receiving device 103b can quickly determine (via techniques discussed below) whether this is actually a two-finger drag from another device, it can quickly fill in the icon with the actual cover being dragged, while the finger is still moving.

When the user lifts his/her fingers on receiving device 130b, device 130b needs to quickly determine whether the left is the culmination of a legitimate two-finger transfer from a neighboring device 130a, and work with server/cloud 150 (see FIG. 8) to make sure the transfer can be effectuated. If it can, the book preferably appears to fall into the home screen or other location on receiving device 130b. There is no significant need to require express acceptance or confirmation of the transfer, as acceptance/confirmation is implied by virtue of the friend allowing the user to drag items to receiving device 30b. Requiring express acceptance or confirmation also would not add extra protection from a “malicious” lending of content, if there is such a thing, over requiring both devices 130a, 103h to be unlocked, and physically next to one another. This is because one would presume to be capable of accessing receiving device 130b to accept/confirm the transfer if devices 130a, 130b are unlocked and in close proximity to one another.

One aspect of the present invention is to detect the user's and friend's intent to transfer digital content between devices 130a, 130b so that devices 130a and 130b may be “paired” for the transfer. This intent may be inferred from any one or a combination of various criteria that must be satisfied before a “pairing” between devices 130a, 130b is effectuated. For example, “pairing” may require that both devices 130a, 103b be logged into to the same ad-hoc local area network or Wi-Fi hotspot 170, i.e., same hotspot SSID or subnet IP address (see FIG. 8). “Pairing” may also require that the two-finger drag onto receiving device 130b occurs within a short period of time (e.g., less than one second) after the user's fingers slide over the frame of sending device 130a. “Pairing” can also require that devices 130a, 103b are thirty well aligned next to one another, so that the entrance spot for the drag on receiving device 103b is close to the exit spot on the sending device 130a, within a certain tolerance (e.g., an inch or 169 pixels up or down). For example, if a user drags semi-transparent copy 215 off sending device 130a exactly halfway up its right edge, semi-transparent copy 215 will be dragged onto receiving device 130b at about half way up its left edge. It can also be required that semi-transparent copy 215 is dragged off and on to opposite edges of devices 130a, 130b (e.g., dragged off the right edge of device 130a and onto the left edge of device 130b, or vice versa). It should be appreciated that any swipe-location constraint as described above is optional in the present invention.

It is possible to pair two devices that are close to one another but not on the same hotspot. A clever client or server based algorithm can infer that two devices are in the same area if they “see” substantially the same set of available hotspots, optionally, at substantially the same signal strengths. If two devices are determined to be in the same vicinity, an intent to transfer content can be inferred from a two-finger slide that enters one of the devices within a short period of time (such as within 1 sec) of a two-finger slide exiting the other device. As noted above, additional constraints may be applied, such as observing the positions along the device edges where slides exit and enter, and ensuring that the exit from one device at least approximately abuts the entrance of the other device. It should be appreciated that pairing devices on different hotspots is more complex and more likely to introduce high latency, compared to pairing devices on the same hotspot. For this reason, certain embodiments focus on supporting transfers between devices that are already known to be on the same hotspot or on the same ad-hoc local area network established via Wi-Fi direct or other means.

In another implementation for pairing the two devices 130a, 103b, both devices 130a, 103b are on a screen for a lending application in their libraries, so both devices are “listening” for lends.

It should be appreciated that peer-to-peer transfer of the content is not necessary because the system need only know which item is being lent or recommended. In such an embodiment, a server/cloud 150 (see FIG. 8) connected to devices 130a, 130b via the Internet 140 can invoke a download of the item's cover and meta data to the target device 130b. Even though the cover and metadata require time to download to receiving device 130b, the process can create the illusion of an instant transfer. Receiving device 130b may draw an outline of a cover along the path of the finger swipe when a finger enters from the side with some velocity while on that screen. Embodiments may implement peer-to-peer file transfer of some types of files after establishing the pairing.

Device Connection Options.

To implement slide-to-lend transfers, the two devices 130a, 103b should be connected in close proximity. Some potential ways to implement this connection are as follows.

1. Multicast Packets. When two devices 130a, 103b are connected via Wi-Fi 170 to the same access point, the most likely case, the sending device 130a may broadcast multicast UDP packets to all devices on the local subnet. The receiving device 130b must be listening for these packets to make the connection. The advantage of this approach is that it is local and fast. The disadvantage is that not all routers permit multicasting, which could cause user frustration.

2. Cloud. This method for connecting two devices 130a, 103b relies on the cloud, remote servers 150, to connect the devices 130a, 103b. Both devices 130a, 103b are connected to the same Wi-Fi access point 170 (See FIG. 8) as described above and have unfettered internet access 140 to common server/cloud 150. Server/cloud 150 tracks each device's current Wi-Fi MAC address and is able to match devices quickly. When the user begins a 2-finger drag from the sending device 130a, it sends the server/cloud 150 a message with the item being dragged. When the user continues the 2-finger drag on receiving device 130b, device 130b contacts server/cloud 150 to determine whether a sending device exists on the network. The advantage of this approach is that it is 100% reliable assuming both devices 130a, 103b are connected to the same Wi-Fi access point 170 and network delay is low. The disadvantage is that long delays in communicating with the server/cloud 150 may create a poor user experience. This approach may also add additional CPU and memory burden to the server/cloud 150.

3. Wi-Fi Ad Hoc. This approach creates an ad hoc Wi-Fi network between devices 130a, 103b. Such an approach advantageously creates a 100% reliable connection between proximate devices 130a, 130b without relying on Wi-Fi access point 170 or server/cloud 150. On the other hand, this approach severs the connection to the server/cloud 150 and may increase the time required to establish a connection between devices 130a, 103b, thereby leading to a degraded user experience.

4. Wi-Fi Direct. Wi-Fi Direct allows devices 130a, 130h to establish an ad hoc network while simultaneously maintaining an existing connection to the Internet 140. In this manner, the content transfer process would not need to wait for an ad hoc network to be established. The network may be kept enabled at all times, or only when the user is both accessing his/her home screen and conducting two-finger slides of items. This approach is advantageous because it does not rely on a connection to Wi-Fi access point 170, the Internet 140, a multicast or server/cloud 150, and does not require closing an Internet connection, to the extent one exists.

Collisions or interceptions. A swipe on to two different potential “receiving” devices within the same area (e.g., the same hotspot) can potentially occur after the swipe off the sending device (or vice-versa) in that area. This may occur either accidentally (called a “collision”) or intentionally, such as when a third party attempts to “intercept” a swipe between two other devices. The system avoids collisions and interceptions by simply requiring that only one sending device and one receiving device are engaged in a transfer operation within the same area. To the extent additional sending and/or receiving devices exist in the area, the system can simply ignore or cancel the transaction. This would require that the transfer process be reinitiated.

FIG. 8 shows components of a system according to the present invention. Sending user 105 is an authorized user of system 100 and uses her local device 130a for the reading of digital content and interacting with other users, such as receiving user 109. Many of the functions of system 100 of the present invention are carried out on server/cloud 150. As appreciated by those skilled in the art, many of the functions described herein can be divided between the server/cloud 150 and the user's local devices 130a, 130b. Further, as also appreciated by those skilled in the art, server/cloud 150 can be considered a “cloud” with respect to the users and their local devices 130a, 130b. The server/cloud 150 can actually be comprised of several servers performing interconnected and distributed functions. For the sake of simplicity in the present discussion, only a single server/cloud 150 will be described. The user 105 can connect to the server/cloud 150 via the Internet 140, a telephone network 145 (e.g., wirelessly through a cellphone network) or other suitable electronic communication means. User 105 has an account on server/cloud 150, which authorizes user 105 to use system 100.

Associated with the user's 105 account is the user's 105 digital locker 120a located on the server/cloud 150. As further described below, in the preferred embodiment of the present invention, digital locker 120a contains links to copies of digital content 125 previously purchased (or otherwise legally acquired) by user 105.

Indicia of rights to all copies of digital content 125 owned by user 105, including digital content 125, is stored by reference in digital locker 120a. Digital locker 120a is a remote online repository that is uniquely associated with the user's 105 account. As appreciated by those skilled in the art, the actual copies of the digital content 125 are not necessarily stored in the user's locker 120a, but rather the locker 120a stores an indication of the rights of the user to the particular content 125 and a link or other reference to the actual digital content 125. Typically, the actual copy of the digital content 125 is stored in another mass storage (not shown). The digital lockers 120 of all of the users 105, 109 who have purchased a copy of a particular digital content 125 would point to this copy in mass storage.

Of course, back up copies of all digital content 125 are maintained for disaster recovery purposes. Although only one example of digital content 125 is illustrated in this Figure, it is appreciated that the lending server/cloud 150 can contain millions of files 125 containing digital content. It is also contemplated that the server/cloud 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

Also contained in the user's digital locker 120a is her contacts list. In a preferred embodiment, the user's contact list will also indicate if the contact is also an authorized (registered) user of the system 100 with his or her own account on server/cloud 150. This information can be use by Slide Between Devices module 160 to swap contact information between users 105, 109 as described above.

User 105 can access his or her digital locker 120a using a local device 130a. Local device 130a is an electronic device such as a personal computer, an e-book reader, a smart phone or other electronic device that the user 105 can use to access the server/cloud 150. In a preferred embodiment, the local device has been previously associated, registered, with the user's 105 account using user's 105 account credentials. Local device 130a provides the capability for user 105 to download user's 105 copy of digital content 125 via his or her digital locker 120a. After digital content 125 is downloaded to local device 130a, user 105 can engage with the downloaded content locally, e.g., read the book, listen to the music or watch the video.

In a preferred embodiment, local device 130a includes a non-browser based device interface that allows user 105 to initiate the discussion functionality of system 100 in a non-browser environment. Through the device interface, the user 105 is automatically connected to the server/cloud 150 in a non-browser based environment. This connection to the server/cloud 150 is a secure interface and can be through the telephone network 145, typically a cellular network for mobile devices. If user 105 is accessing his or her digital locker 120a using the Internet 140, local device 130a also includes a web account interface. Web account interface provides user 105 with browser-based access to his or her account and digital locker 120a over the Internet 140.

User 109 is also an authorized user of system 100. As with user 105, user 109 has an account with lending server/cloud 150, which authorizes user 109 to use lending system 100. As appreciated by those skilled in the art, the number of users 105, 109 that employ the present invention at the same time is only limited by the scalability of server/cloud 150. As with user 105, user 109 can access his or her digital locker 120b using her local device 130b. In a preferred embodiment, local device 130b is a device that user 109 has previously associated, registered, with his or her account using user's 109 account credentials. Local device 130h allows user 109 to download copies of his digital content 125 from digital locker 120b. User 109 can engage with downloaded digital content 125 locally on local device 130b.

The Slide Between Devices module 160 performs the “cloud” operations discussed herein. Further, the Slide Between Devices module 160 coordinates with the other components of server/cloud 150 to facilitate the loan or recommendation of digital content as described in co-pending application U.S. Ser. No. 13/154,350 filed Jun. 6, 2011, the entirety of which is incorporated herein by reference.

Devices 130a and 130b can further be connected via Wi-Fi AP 170, as described above.

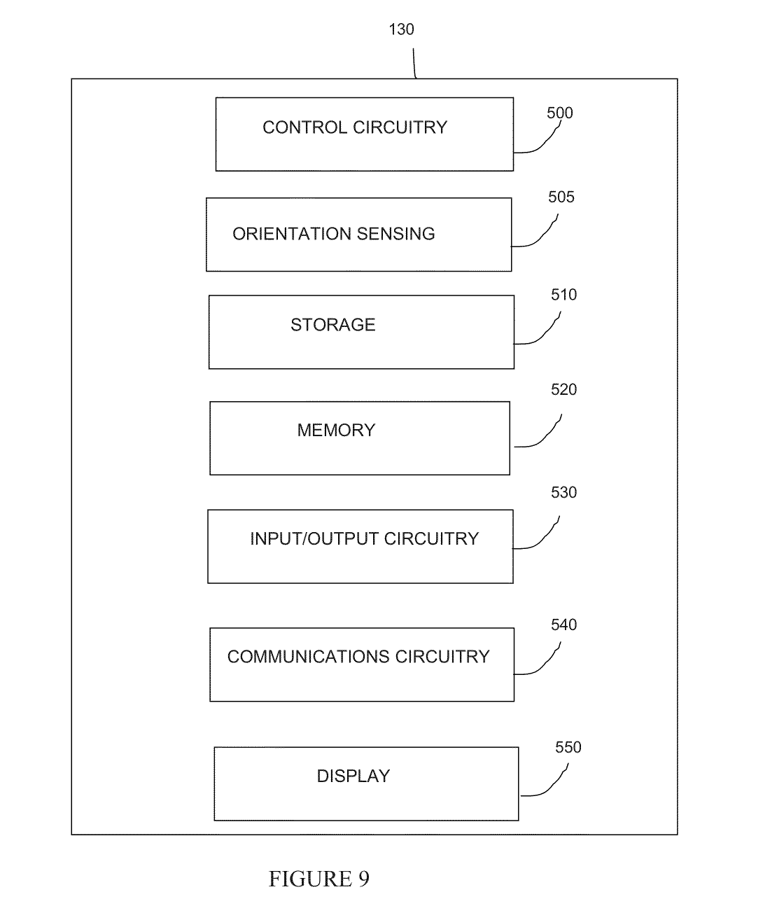

FIG. 9 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in this Figure, e.g., a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 include orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 130 as a whole. The orientation data is then fed to the control circuitry 500 which control an orientation sensing application. The orientation sensing application controls the graphical user interface (GUI), which drives the display 550 to present the GUI for the desired mode.

Storage 530 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 130 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 530.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in this Figure as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, that is incorporated in electronics device 130. In some embodiments, the display circuitry can include a coder/decoder (Codec) to convert digital media data into analog signals. For example, the display circuitry or other appropriate circuitry within electronic device can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-H, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOW, or any other suitable protocol.

Electronic device 130 can include one more instances of communications circuitry 540 for simultaneously performing several communications operations using different communications networks, although only one is shown in this Figure to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server/cloud 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. An electronic device for viewing, transferring and receiving information associated with first and second electronic files, the electronic device comprising:
a first touch screen configured to display at least one first icon associated with the first electronic file; and
a control unit electronically coupled to the first touch screen, the control unit configured to transfer information associated with the first electronic file to a second electronic device in close proximity when the first icon is finger-swiped in a single continuous motion from the first touch screen to a second touch screen of the second electronic device,
the control unit being further configured to receive information associated with the second electronic file when a second icon associated with the second electronic file is finger-swiped in a single continuous motion from the second touch screen of the second electronic device to the first touch screen.

2. The electronic device of claim 1, wherein the information associated with the first electronic file is one of a complete copy of the first electronic file and a sample of the first electronic file, and the information associated with the second electronic file is one of a complete copy of the second electronic file and a sample of the second electronic file.

3. The electronic device of claim 2, wherein the control unit is further configured to pair with the second electronic device automatically in accordance with pairing criteria, the information associated with the first electronic file being transferred to the second device only if the pairing criteria are satisfied.

4. The electronic device of claim 3, wherein the finger-swipe of the first icon consists of a first finger-swipe toward an edge of the first touch screen and a second finger-swipe away from an edge of the second touch screen, the pairing criteria being satisfied only if the second finger-swipe occurs within a predetermined time of the first finger-swipe.

5. The electronic device of claim 4, wherein the control unit is further configured to transmit a first signal to a central server over a communications network upon the occurrence of the first finger-swipe, the server determining whether the second finger-swipe occurs within a predetermined time of the first finger-swipe based on the first signal and based on a second signal received from the second electronic device upon the occurrence of the second finger-swipe.

6. The electronic device of claim 4, wherein the pairing criteria are satisfied only if at least one of the following attributes is detected: (a) the edges of the first touch screen and the second touch screen are opposite edges, (b) the second electronic device is on the same Wi-Fi network, (c) the second electronic device is on the same Wi-Fi network at the same signal strength, (d) the second electronic device is on the same ad-hoc network, and (e) the first touch screen and the second touch screen are properly aligned within a predetermined tolerance.

7. The electronic device of claim 4, wherein the pairing criteria are not satisfied if a third electronic device in proximity to the first and second electronic devices is engaged in a potential transfer operation.

8. The electronic device of claim 2, wherein the control unit is further configured to pair with the second electronic device automatically in accordance with pairing criteria, the information associated with the second electronic file being received only if the pairing criteria is satisfied.

9. The electronic device of claim 8, wherein the finger-swipe of the second icon consists of a first finger-swipe toward an edge of the second touch screen and a second finger-swipe away from an edge of the first touch screen, the paring criteria being satisfied only if the second finger-swipe occurs within a predetermined time of the first finger-swipe.

10. The electronic device of claim 9, wherein the control unit is further configured to transmit a first signal to a central server over a communications network upon the occurrence of the first finger-swipe, the server determining whether the second finger-swipe occurs within a predetermined time of the first finger-swipe based on the first signal and based on a second signal received from the second electronic device upon the occurrence of the second finger-swipe.

11. The electronic device of claim 9, wherein the paring criteria are satisfied only if at least one of the following attributes is detected: (a) the edges of the first touch screen and the second touch screen are opposite edges, (b) the second electronic device is on the same Wi-Fi network, (c) the second electronic device is on the same Wi-Fi network at the same signal strength, (d) the second electronic device is on the same ad-hoc network, and (e) the first touch screen and the second touch screen are aligned with one another within a predetermined tolerance.

12. The electronic device of claim 2, wherein the control unit is further configured to receive the information associated with the second electronic file from one of the second electronic device and a central server.

13. A method for transferring information from a first electronic device, the method comprising:
monitoring a first touch screen of the first electronic device for finger-swipes, the first touch screen displaying an icon associated with an electronic file;
detecting a first continuous finger-swipe of the icon toward an edge of the first touch screen;
detecting attributes associated with a second electronic device;
determining whether pairing criteria are satisfied based on the attributes associated with the second electronic device; and
transferring information associated with the electronic file from the first electronic device to the second electronic device if the pairing criteria are satisfied.

14. The method of claim 13, wherein the information associated with the electronic file is one of a complete copy of the electronic file and a sample of the electronic file.

15. The method of claim 14, wherein the pairing criteria are satisfied only if a second continuous finger-swipe away from an edge of a second touch screen of the second electronic device occurs within a predetermined time of the first continuous finger-swipe.

16. The method of claim 15, further comprising transmitting a first signal to a central server over a communications network upon the occurrence of the first continuous finger-swipe, the server determining whether the second continuous finger-swipe occurs within a predetermined time of the first continuous finger-swipe based on the first signal and based on a second signal received from the second electronic device upon the occurrence of the second continuous finger-swipe.

17. The method of claim 15, wherein the pairing criteria are satisfied only if at least one of the following attributes associated with the second electronic device is detected: (a) the edge of the second touch screen is opposite to the edge of the first touch screen, (h) the second electronic device is on the same Wi-Fi network as the first electronic device, (c) the second electronic device is on the same Wi-Fi network as the first electronic device and is at the same signal strength, (d) the second electronic device is on the same ad-hoc network as the first electronic device, and (e) the second touch screen of the second electronic device is properly aligned with the first touch screen of the first electronic device within a predetermined tolerance.

18. The method of claim 15, wherein the pairing criteria are not satisfied if a third electronic device in proximity to the first and second electronic devices is engaged in a potential transfer operation.

19. A non-transitory computer-readable media comprising a plurality of instructions that, when executed, cause a first electronic device to:
monitor a first touch screen of the first electronic device for finger-swipes, the first touch screen displaying an icon associated with an electronic file;
detect a first continuous finger-swipe of the icon toward an edge of the first touch screen;
detect attributes associated with a second electronic device;
determine whether pairing criteria are satisfied based on the attributes associated with the second electronic device; and
transfer information associated with the electronic file from the first electronic device to the second electronic device if the pairing criteria are satisfied.

20. The non-transitory computer-readable media of claim 19, wherein the information associated with the electronic file is one of a complete copy of the electronic file and a sample of the electronic file.

21. The non-transitory computer-readable media of claim 20, wherein the pairing criteria are satisfied only if a second continuous finger-swipe away from an edge of a second touch screen of the second electronic device occurs within a predetermined time of the first continuous finger-swipe.

22. The non-transitory computer-readable media of claim 21 further comprising instructions that cause the first electronic device to transmit a first signal to a central server over a communications network upon the occurrence of the first continuous finger-swipe, the server determining whether the second continuous finger-swipe occurs within a predetermined time of the first continuous finger-swipe based on the first signal and based on a second signal received from the second electronic device upon the occurrence of the second continuous finger-swipe.

23. The non-transitory computer-readable media of claim 21, wherein the pairing criteria are satisfied only at least one of the following attributes associated with the second electronic device is detected: (a) the edge of the second touch screen is opposite to the edge of the first touch screen, (b) the second electronic device is on the same Wi-Fi network as the first electronic device, (c) the second electronic device is on the same Wi-Fi network as the first electronic device and is at the same signal strength, (d) the second electronic device is on the same ad-hoc network as the first electronic device, and (e) the second touch screen of the second electronic device is properly aligned with the first touch screen of the first electronic device within a predetermined tolerance.

24. The non-transitory computer-readable media of claim 21, wherein the pairing criteria are not satisfied if a third electronic device in proximity to the first and second electronic devices is engaged in a potential transfer operation.

25. A method for receiving information from a second electronic device, the method comprising:
monitoring a first touch screen of a first electronic device for finger-swipes;
detecting a first continuous finger-swipe away from an edge of the first touch screen;
detecting attributes associated with the second electronic device;
determining whether pairing criteria are satisfied based on the attributes associated with the second electronic device; and
receiving information associated with an electronic file if the pairing criteria are satisfied.

26. The method of claim 25, wherein the information associated with the electronic file is one of a complete copy of the electronic file and a sample of the electronic file.

27. The method of claim 26, wherein the pairing criteria are satisfied only if a second continuous finger-swipe of an icon toward an edge of a second touch screen of the second electronic device occurs within a predetermined time of the first continuous finger-swipe.

28. The method of claim 27, further comprising transmitting a first signal to a central server over a communications network upon the occurrence of the first continuous finger-swipe, the server determining whether the second continuous finger-swipe occurs within a predetermined time of the first continuous finger-swipe based on the first signal and based on a second signal received from the second electronic device upon the occurrence of the second continuous finger-swipe.

29. The method of claim 27, wherein the pairing criteria are satisfied only if at least one of the following attributes associated with the second electronic device is detected: (a) the edge of the second touch screen is opposite to the edge of the first touch screen, (b) the second electronic device is on the same Wi-Fi network as the first electronic device, (c) the second electronic device is on the same network as the first electronic device and is at the same signal strength, (d) the second electronic device is on the same ad-hoc network as the first electronic device, and (e) the second touch screen of the second electronic device is properly aligned with the first touch screen of the first electronic device within a predetermined tolerance.

30. The method of claim 27, wherein the pairing criteria are not satisfied if a third electronic device in proximity to the first and second electronic devices is engaged in a potential transfer operation.

31. A non-transitory computer-readable media comprising a plurality of instructions that, when executed, cause a first electronic device to:
monitor a first touch screen of a first electronic device for finger-swipes;
detect a first continuous finger-swipe away from an edge of the first touch screen;
detect attributes associated with a second electronic device;
determine whether pairing criteria are satisfied based on the attributes associated with the second electronic device; and
receive information associated with an electronic file if the first finger-swipe is detected and the pairing criteria are satisfied.

32. The non-transitory computer-readable media of claim 31, wherein the information associated with the electronic file is one of a complete copy of the electronic file and a sample of the electronic file.

33. The non-transitory computer-readable media of claim 32, wherein the pairing criteria are satisfied only if a second continuous finger-swipe of an icon toward an edge of a second touch screen of the second electronic device occurs within a predetermined time of the first continuous finger-swipe.

34. The non-transitory computer-readable media of claim 33, further comprising instructions that cause the first electronic device to transmit a first signal to a central server over a communications network upon the occurrence of the first continuous finger-swipe, the server determining whether the second continuous finger-swipe occurs within a predetermined time of the first continuous finger-swipe based on the first signal and based on a second signal received from the second electronic device upon the occurrence of the second continuous finger-swipe.

35. The non-transitory computer-readable media of claim 33, wherein the paring criteria are satisfied only if at least one of the following attributes associated with the second electronic device is detected: (a) the edge of the second touch screen is opposite to the edge of the first touch screen, (b) the second electronic device is on the same Wi-Fi network as the first electronic device, (c) the second electronic device is on the same Wi-Fi network as the first electronic device and is at the same signal strength, (d) the second electronic device is on the same ad-hoc network as the first electronic device, and (e) the second touch screen of the second electronic device is properly aligned with the first touch screen of the first electronic device within a predetermined tolerance.

36. The non-transitory computer-readable media of claim 33, wherein the pairing criteria are not satisfied if a third electronic device in proximity to the first and second electronic devices is engaged in a potential transfer operation.
